(19) United States
(12) Patent Application Publication
(10) Pub. No.: US 2021/0012268 A1
(43) Pub. Date: Jan. 14, 2021

(54) SYSTEMS AND METHODS FOR EMPLOYMENT EVALUATION FOR INDIVIDUALS WITH DISABILITIES

(71) Applicant: Ligilo Inc., Richmond, VA (US)

(72) Inventors: Charlotte Newman Kohlmann, Richmond, VA (US); Marios Politis, London (GB); Robert E. Morgan, Peoria, AZ (US)

(73) Assignee: Ligilo Inc., Richmond, VA (US)

(21) Appl. No.: 16/926,412

(22) Filed: Jul. 10, 2020

Related U.S. Application Data
(60) Provisional application No. 62/873,559, filed on Jul. 12, 2019.

(51) Int. Cl. G06Q 10/06; G06Q 10/10

(52) U.S. Cl. CPC G06Q 10/063112; G06Q 10/06393; G06Q 10/1053

(57) ABSTRACT

A method including obtaining a plurality of job titles in which each of the plurality of job titles is associated with a plurality of job elements. The method also can include assigning a respective importance value to each respective job element of the plurality of job elements for each of the plurality of job titles. The method additionally can include determining action scores for an applicant. Each respective action score of the action scores is based at least in part on a respective ability of the applicant in performing each of a plurality of abilities related to one or more disabilities. The method further can include generating a respective final score for each job title of the plurality of job titles based at least in part on the respective importance values assigned to the plurality of job elements associated with the job title and the action scores for the applicant. The method additionally can include generating a stratification of the plurality of job titles based at least in part on the respective final scores for the plurality of job titles. The method further can include determining first job titles of the plurality of job titles for presentation to the applicant based at least in part on the stratification. The method additionally can include sending job postings to the applicant based on the first job titles. Other embodiments are described.

### CROSS-REFERENCE TO RELATED APPLICATION

This application claims the benefit of U.S. Provisional Application No. 62/873,559, filed Jul. 12, 2019. U.S. Provisional Application No. 62/873,559 is incorporated herein by reference in its entirety.

### TECHNICAL FIELD

The disclosure relates generally to systems and methods for employment evaluation for individuals with disabilities.

### BACKGROUND

Conventional job-search platforms allow applicants to search for jobs that may be suitable for the skills and/or experience of the applicant. Many individuals experience various disabilities. For example, an individual may have a chronic medical condition, such as multiple sclerosis, which can limit the individual's ability to perform certain job functions. As another example, an individual may have difficulty walking after experiencing a stroke. Conventional platforms do not take into consideration the disabilities of the applicant and/or specific requirements of and accommodations for a job related to such disabilities.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system for employment evaluation individuals with disabilities, according to an embodiment;

FIG. 4 illustrates a flow diagram showing activities that can be performed by the employment system of FIG. 3 when the employment system of FIG. 3 is used by an applicant;

FIG. 5 illustrates a flow diagram showing activities that can be performed by the employment system of FIG. 3 when the employment system of FIG. 3 is used by an employer;

FIG. 6 illustrates a flow diagram showing activities that can be performed by the employment system of FIG. 3 when the employment system of FIG. 3 is used by a recruiter and/or a sponsor; and

FIG. 7 illustrates a flow diagram showing activities that can be performed by the employment system of FIG. 3 when the employment system of FIG. 3 is used by a researcher;

FIG. 8 illustrates a flow chart for a method of evaluating employment opportunities for an individual with disabilities, according to an embodiment;

FIG. 9 illustrates a flow chart for an activity of generating a respective final score for each job title, according to the embodiment of FIG. 8; and

FIG. 10 illustrates a flow chart for an activity of determining first job titles for presentation to the applicant, according to the embodiment of FIG. 8.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Various embodiments can include a system including one or more processors and one or more non-transitory computer-readable media storing computing instructions configured to run on the one or more processors and perform certain acts. The acts can include obtaining a plurality of job titles. Each of the plurality of job titles is associated with a plurality of job elements. The acts also can include assigning a respective importance value to each respective job element of the plurality of job elements for each of the plurality of job titles. The acts additionally can include determining action scores for an applicant. Each respective action score of the action scores is based at least in part on a respective ability of the applicant in performing each of a plurality of abilities related to one or more disabilities. The acts further can include generating a respective final score for each job title of the plurality of job titles based at least in part on the respective importance values assigned to the plurality of job elements associated with the job title and the action scores for the applicant. The acts additionally can include generating a stratification of the plurality of job titles based at least in part on the respective final scores for the plurality of job titles. The acts further can include determining first job titles of the plurality of job titles for presentation to the applicant based at least in part on the stratification. The acts additionally can include sending job postings to the applicant based on the first job titles.

A number of embodiments can include a method being implemented via execution of computing instructions configured to run at one or more processors and stored at one or more non-transitory computer-readable media. The method can include obtaining a plurality of job titles. Each of the plurality of job titles is associated with a plurality of job elements. The method also can include assigning a respective importance value to each respective job element of the plurality of job elements for each of the plurality of job titles. The method additionally can include determining action scores for an applicant. Each respective action score of the action scores is based at least in part on a respective ability of the applicant in performing each of a plurality of abilities related to one or more disabilities. The method further can include generating a respective final score for each job title of the plurality of job titles based at least in part on the respective importance values assigned to the plurality of job elements associated with the job title and the action scores for the applicant. The method additionally can include generating a stratification of the plurality of job titles based at least in part on the respective final scores for the plurality of job titles. The method further can include determining first job titles of the plurality of job titles for presentation to the applicant based at least in part on the stratification. The method additionally can include sending job postings to the applicant based on the first job titles.

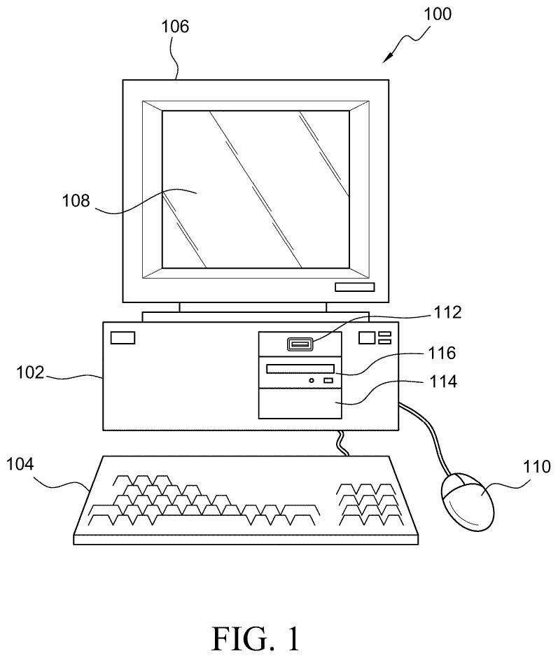

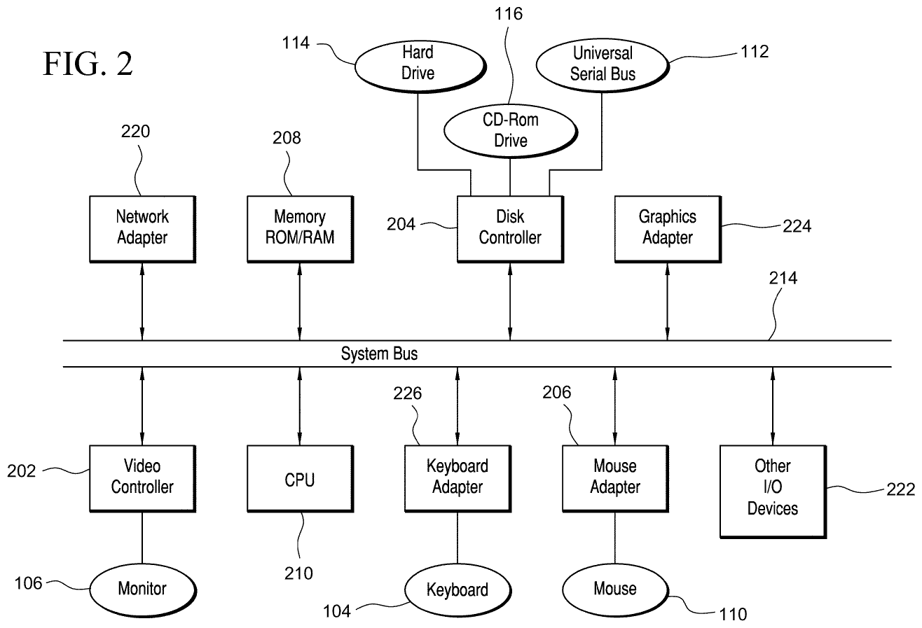

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, or (v) the Windows Mobile™ operating system by Microsoft Corp. of Redmond, Wash., United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

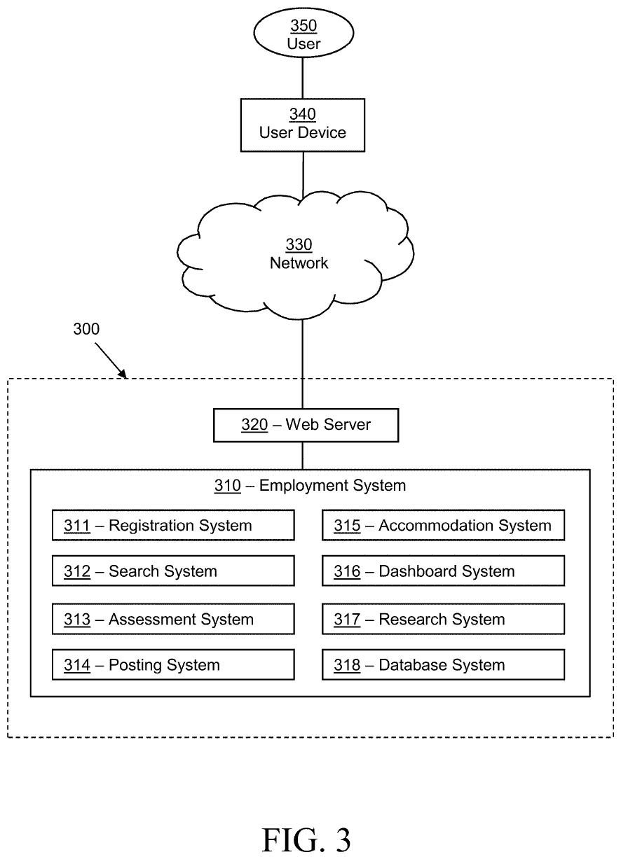

Turning ahead in the drawings, FIG. 3 illustrates a block diagram of a system 300 that can be employed for employment evaluation for individuals with disabilities, according to an embodiment. System 300 is merely exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include an employment system 310 and/or web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Employment system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host employment system 310 and web server 320. In some embodiments, employment system 310 can be integrated with web server 320. Additional details regarding employment system 310 and/or web server 320 are described herein.

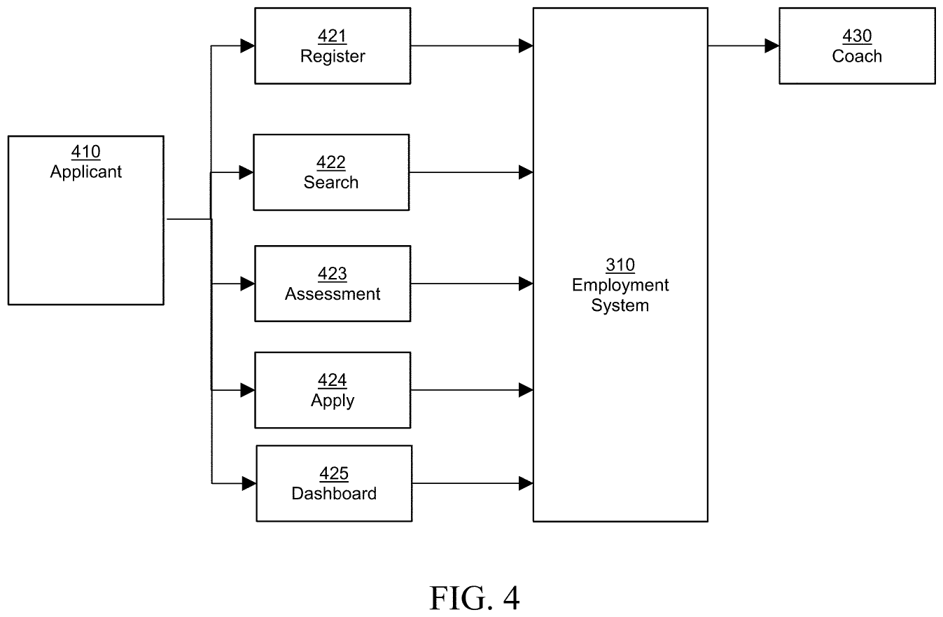

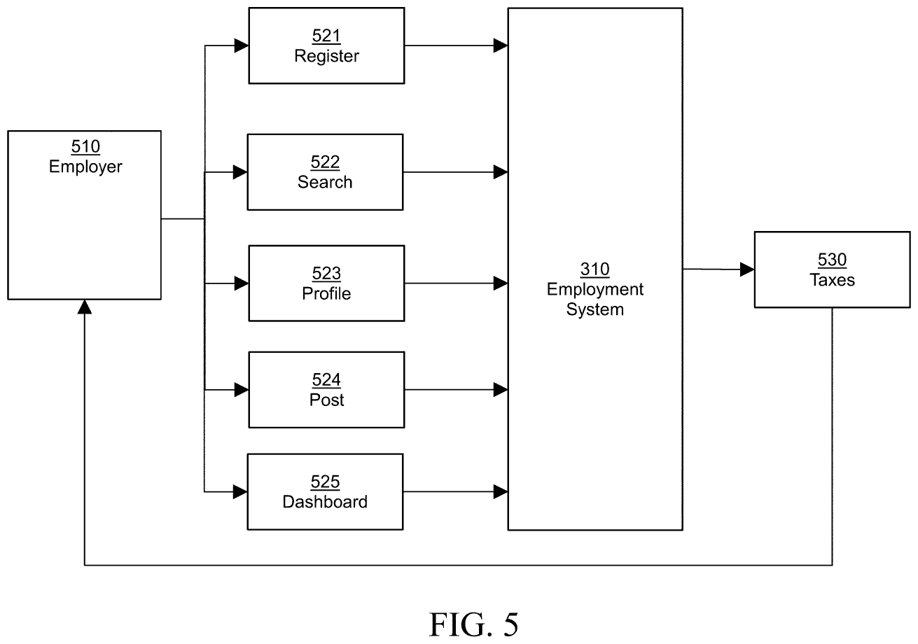

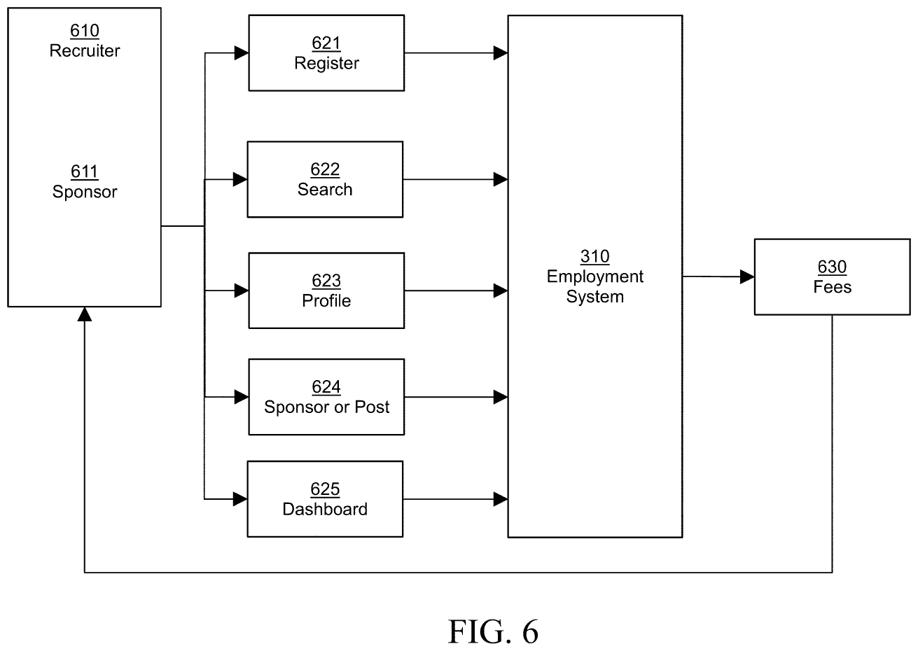

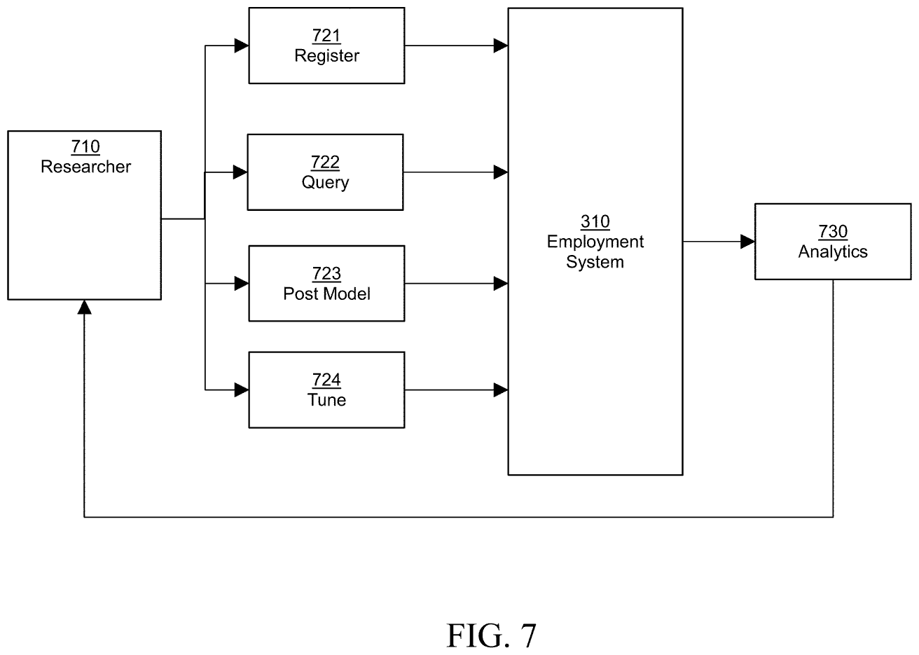

In some embodiments, web server 320 can be in data communication through a network 330 with one or more user devices, such as a user device 340, and/or with one or more content servers 360. Network 330 can be the Internet or another network, such as an intranet or another suitable network. In a number of embodiments, the user devices (e.g., 340) can be used by users, such as a user 350. For example, users (e.g., 350) can include applicants (e.g., applicant 410 (FIG. 4), described below), employers (e.g., employer 510 (FIG. 5), described below), recruiters (e.g., recruiter or sponsor 610 (FIG. 6), described below), researchers (e.g., researcher 710 (FIG. 7), described below), sponsors (e.g., recruiter or sponsor 610 (FIG. 6), described below), and/or other suitable users.

In many embodiments, web server 320 can host one or more websites, one or more mobile application servers, one or more text messaging servers, and/or one or more other suitable servers or interfaces for communication with user device 340. For example, in some embodiments, web server 320 can communicate with users device 240 through an application programming interfaces (API). In many embodiments, user device 340 can include a web browser, which can be used to display webpages from the website hosted by system 300. For example, the web browser can include Google Chrome, Firefox, Internet Explorer, Opera, Safari, Microsoft Edge, or another suitable web browser. In the same or other embodiments, user device 340 can include a mobile application configured to communicate with a mobile application server in web server 320. In the same or other embodiments, user device 340 can include a text messaging application and/or other suitable communication applications for communication with web server 320.

In a number of embodiments, an internal network that is not open to the public can be used for communications between employment system 310 and web server 320 within system 300. Accordingly, in some embodiments, employment system 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300. In other embodiments, employment system 310 and web server 320 can communicate through a public network, such as the Internet.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a GalaxyTM or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, or (v) the Windows Mobile™ operating system by Microsoft Corp. of Redmond, Wash., United States of America.

In many embodiments, employment system 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to employment system 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of employment system 310 and/or web server 320. In a similar manner, the processors and/or the non-transitory computer-readable media can be local and/or remote to each other.

Meanwhile, in many embodiments, employment system 310 and/or web server 320 also can be configured to communicate with one or more databases, such as an database system 318. The one or more databases can include medical disorder data, job codes data, job openings posted by employers, for example, and other suitable. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP Database, and IBM DB2 Database.

Meanwhile, communication between employment system 310 and/or web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In some embodiments, employment system 310 can include a registration system 311, a search system 312, an assessment system 313, a posting system 314, an accommodation system 315, a dashboard system 316, a research system 317, database system 318, and/or other suitable systems and/or databases. In many embodiments, the systems of employment system 310 can be modules of computing instructions (e.g., software modules) stored at non-transitory computer readable media that operate on one or more processors. In the same or other embodiments, one of more of the systems of employment system 310 can be implemented in hardware. The systems of employment system 310 described herein are merely exemplary, and other suitable arrangements of systems within employment system 310 are contemplated. The systems of employment system 310 are described below in further detail.

Turning ahead in the drawings, FIG. 4 illustrates a flow diagram showing activities that can be performed by employment system 310 when employment system 310 is used by an applicant 410. The activities shown in FIG. 4 are merely exemplary, and the activities that can be performed by employment system 310 are not limited to the activities presented herein. “Applicant(s)” (e.g., 410) can include individuals and/or entities seeking a job position, such as seeking a suitable job position through employment system 310. “Job position” can be used interchangeably with other terms, such as “job,” “position,” “employment,” or “career,” and can include any form of work arrangement, including full-time employment, part-time employment, fixed-term work, temporary work, apprenticeships, internships, contract work, on-call work, and/or other suitable work arrangements, and can include paid and/or unpaid work arrangements.

In many embodiments, as shown in FIG. 4, employment system 310 can be used by applicant 410 to perform an activity 421 of registering with employment system 310. In some embodiments, registration system 311 (FIG. 3) can perform activity 421. For example, applicant 410 can create an account in employment system 310 and/or setup a username and password. As another example, applicant 410 can setup a profile in employment system 310. In some embodiments, setting up a profile can include applicant 410 inputting information into employment system 310 about applicant 410, including information about the abilities and/or disabilities of applicant 410, and/or requested accommodations.

In several embodiments, employment system 310 can be used by applicant 410 to perform an activity 422 of searching for job postings. In some embodiments, search system 312 (FIG. 3) can perform activity 422. In a number of embodiments, applicant 410 can search for job postings related to one or more accommodations and/or disabilities of applicant 410. In certain embodiments, for example, applicant 410 can perform a search for job postings using employment system 310 based on search options related to one or more abilities, disabilities, disorders, accommodations, medical conditions, etc. In many embodiments, job postings can be presented to applicant 410 in order of priority and/or relevance based on the abilities of applicant 410, as described below in further detail.

In many embodiments, employment system 310 can be used by applicant 410 to perform an activity 423 of completing or partially completing an assessment. In several embodiments, assessment system 313 (FIG. 3) perform activity 423. In a number of embodiments, the assessment can be used by employment system 310 to determine the abilities and/or disabilities of applicant 410 to perform various skills and/or tasks. In many embodiments, employment system 310 can present applicant 410 with a series of questions to perform a self-assessment. For example, a series of 20-25 questions can be presented to applicant 410, and applicant 410 can answer each question with a score ranging from 0 to 10, with 0 corresponding to full independence (normal without disability) and 10 corresponding to full incapacitation. In other embodiments, other suitable numbers of questions and/or scoring approaches are used. In several embodiments, the questions can be expressed in lay language in order to be clearly understood by applicant 410 without consulting a doctor. Each question can address different job specifications, such as physical abilities, cognitive abilities, social skills, driving ability, and/or other suitable abilities. The answers from applicant 410 can be referred to as “action scores.”

In several embodiments, employment system 310 can be used by applicant 410 to perform an activity 424 of applying for job openings through employment system 310. In some embodiments, posting system 314 (FIG. 3) can perform activity 424. In many embodiments, if applicant 410 uses employment system 310 to search for job openings and finds one or more job postings that are relevant or suitable for applicant 410, applicant 410 can apply for those job positions. Employment system 310 can notify employers (e.g., 510 (FIG. 5), described below)) that posted those job postings of the applications by applicant 410.

In many embodiments, employment system 310 can be used by applicant 410 to perform an activity 425 of displaying a dashboard. In some embodiments, dashboard system 316 (FIG. 3) can perform activity 425. In a number of embodiments, the dashboard can be provided to applicant 410 to monitor the status of the pending job applications and/or view other information or analytics regarding use of employment system 310 by applicant 410.

In some embodiments, employment system 310 can provide various outputs to applicant 410 in addition to, or alternative to, the information provided to applicant 410 as described above in connection with activities 421-425. As an example, employment system 310 can perform an activity 430 of coaching to applicant 410. For example, employment system 310 can provide guidance to applicant 410 and/or can match applicant 410 with a coach to provide coaching to applicant 410 through the job search process. The coaching and/or guidance can assist applicant 410 with preparing a resume, accommodation request, and/or cover letter, preparing for a job interview, and/or preparing for working at the job position, depending on the abilities and/or disabilities of applicant 410.

Turning ahead in the drawings, FIG. 5 illustrates a flow diagram showing activities that can be performed by employment system 310 when employment system 310 is used by an employer 510. The activities shown in FIG. 5 are merely exemplary, and the activities that can be performed by employment system 310 are not limited to the activities presented herein. “Employer(s)” (e.g., 510) can include individuals and/or entities offering one or more job positions, such as offering one or more job positions through one or more job postings on employment system 310.

In many embodiments, as shown in FIG. 5, employment system 310 can be used by employer 510 to perform an activity 521 of registering with employment system 310. In some embodiments, registration system 311 (FIG. 3) can perform activity 521. For example, employer 510 can create an account in employment system 310 and/or setup a username and password.

In a number of embodiments, employment system 310 can be used by employer 510 to perform an activity 522 of searching for applicants and/or job postings using employment system 310. In some embodiments, search system 312 (FIG. 3) can perform activity 522. For example, employer 510 can use employment system 310 to find applicants (e.g., 410 (FIG. 4)) using search options related to one or more abilities, disabilities, disorders, accommodations, etc., and/or to see other job postings that are already posted by the same or other employers (e.g., 510).

In many embodiments, employment system 310 can be used by employer 510 to perform an activity 523 of creating and/or updating a profile for employer 510 on employment system 310. In some embodiments, registration system 311 (FIG. 3) can perform activity 523. In a number of embodiments, the profile can include suitable information about employer 510, such as the culture of employer 510, the mission of employer 510, benefits offered by employer 510, industries served by of employer 510, human resources contacts at employer 510, and/or other suitable information about employer 510.

In some embodiments, employment system 310 can be used by employer 510 to perform an activity 524 of posting one or more job openings on employment system 310. In some embodiments, posting system 314 (FIG. 3) can perform activity 524. For example, employer 510 can create one or more job postings for job positions offered by employer 510, which express the accommodations available and/or abilities required for the specific position and location.

In many embodiments, employment system 310 can be used by employer 510 to perform an activity 525 of displaying a dashboard. In some embodiments, dashboard system 316 (FIG. 3) can perform activity 525. In a number of embodiments, the dashboard can be provided to employer 510 to monitor the status of the job postings posted by employer 510. For example, employer 510 can access information and/or analytics about applicants (e.g., 410 (FIG. 4)) who have viewed and/or applied for the job postings. As another example, employer 510 can access the applications submitted for the job postings.

In some embodiments, employment system 310 can provide various outputs to employer 510 in addition to, or alternative to, the information provided to employer 510 as described above in connection with activities 521-525. As an example, employment system 310 can perform an activity 530 of providing employer 510 with the ability to apply for one or more tax credits after employer 510 has hired an applicant with a disability.

Turning ahead in the drawings, FIG. 6 illustrates a flow diagram showing activities that can be performed by employment system 310 when employment system 310 is used by a recruiter 610 and/or sponsor 611. The activities shown in FIG. 6 are merely exemplary, and the activities that can be performed by employment system 310 are not limited to the activities presented herein. “Recruiter(s)” (e.g., 610) can include individuals and/or entities representing employers in identifying applicants (e.g., 410 (FIG. 4)) for a job position and/or representing applicants in identifying job positions for applicants. “Sponsor(s)” (e.g., 611) can include individuals and/or entities, such as foundations, agencies (e.g., federal, state, etc.), and/or other suitable sponsors, who can provide funds, goods, and/or services for applicants, employers, recruiters, and/or job positions. For example, a foundation for multiple sclerosis can recruit applicants who have multiple sclerosis, and/or can sponsor job positions suitable for applicants with multiple sclerosis.

In many embodiments, as shown in FIG. 6, employment system 310 can be used by recruiter 610 and/or sponsor 611 to perform an activity 621 of registering with employment system 310. In some embodiments, registration system 311 (FIG. 3) can perform activity 621. For example, recruiter 610 and/or sponsor 611 can create an account in employment system 310 and/or setup a username and password.

In a number of embodiments, employment system 310 can be used by recruiter 610 and/or sponsor 611 to perform an activity 622 of searching for applicants and/or job postings using employment system 310. In some embodiments, search system 312 (FIG. 3) can perform activity 622. For example, recruiter 610 and/or sponsor 611 can use employment system 310 to search for job postings using employment system 310 based on search options related to one or more abilities, disabilities, disorders, accommodations, medical conditions, etc., to find applicants (e.g., 410 (FIG. 4)) using search options related to one or more abilities, disabilities, disorders, accommodations, etc., and/or to see other job postings that have been posted by employers (e.g., 510).

In many embodiments, employment system 310 can be used by recruiter 610 and/or sponsor 611 to perform an activity 623 of creating and/or updating a profile for recruiter 610 and/or sponsor 611 on employment system 310. In some embodiments, registration system 311 (FIG. 3) can perform activity 623. In a number of embodiments, the profile can include suitable information about recruiter 610 and/or sponsor 611, and/or information about the services and/or funding offered by recruiter 610 and/or sponsor 611.

In some embodiments, employment system 310 can be used by recruiter 610 and/or sponsor 611 to perform an activity 624 of posting information about a sponsorship and/or post one or more job openings on employment system 310. In some embodiments, posting system 314 (FIG. 3) can perform activity 624. For example, sponsor 611 can sponsor a job position and/or an applicant (e.g., 410 (FIG. 4)). As another example, recruiter 610 can post a job posting on behalf of an employer (e.g., 510 (FIG. 5)).

In many embodiments, employment system 310 can be used by employer 510 to perform an activity 625 of displaying a dashboard. In some embodiments, dashboard system 316 (FIG. 3) can perform activity 625. In a number of embodiments, the dashboard can be provided to recruiter 610 and/or sponsor 611 to monitor the status of the applicants (e.g., 410 (FIG. 4)) and/or the job postings associated with recruiter 610 and/or sponsor 611. For example, recruiter 610 and/or sponsor 611 can access information and/or analytics about the applicants (e.g., 410 (FIG. 4)) who have viewed and/or applied for a job posting. As another example, For example, recruiter 610 and/or sponsor 611 can access information and/or analytics about which job postings have be viewed and/or applied for by an applicant (e.g., 410 (FIG. 4)) who was recruited by recruiter 610 and/or sponsored by sponsor 611.

In some embodiments, employment system 310 can provide various outputs to recruiter 610 and/or sponsor 611 in addition to, or alternative to, the information provided to recruiter 610 and/or sponsor 611 as described above in connection with activities 621-625. As an example, employment system 310 can perform an activity 630 of providing recruiter 610 with an allocated fee based on the services provided by recruiter 610 when an applicant (e.g., 410 (FIG. 4)) starts a job at an employment for which recruiter 610 represented employer 510 in posting the job and/or recruiting the applicant (e.g., 410 (FIG. 4)) to the job posting.

Turning ahead in the drawings, FIG. 7 illustrates a flow diagram showing activities that can be performed by employment system 310 when employment system 310 is used by a researcher 710. The activities shown in FIG. 7 are merely exemplary, and the activities that can be performed by employment system 310 are not limited to the activities presented herein. “Researcher(s)” (e.g., 710) can include to individuals and/or entities that interact with employment system 310 to access information and/or update models in employment system 310, such as to tune employment system 310.

In many embodiments, as shown in FIG. 7, employment system 310 can be used by researcher 710 to perform an activity 721 of registering with employment system 310. In some embodiments, registration system 311 (FIG. 3) can perform activity 721. For example, researcher 710 can create an account in employment system 310 and/or setup a username and password.

In several embodiments, employment system 310 can be used by researcher 710 to perform an activity 722 of querying employment system 310 for information. In some embodiments, research system 312 (FIG. 3) can perform activity 722. In a number of embodiments, research 710 can query information such as statistics about applicants (e.g., 410 (FIG. 4)) finding job openings using employment system 310, internal calculations and/or scoring of models, and/or other suitable information.

In many embodiments, employment system 310 can be used by researcher 710 to perform an activity 723 of posting a model that can be used by employment system 310. In some embodiments, research system 312 (FIG. 3) can perform activity 723. For example, the calculations and/or scoring procedures that are done by employment system 310 in matching applicants (e.g., 410 (FIG. 4)) to job openings based on abilities and/or accommodations can be updated by positing a new model.

In a number of embodiments, employment system 310 can be used by researcher 710 to perform an activity 724 of tuning the model by updating the model. In some embodiments, research system 312 (FIG. 3) can perform activity 724. For example, when a model is posted, A/B testing can be performed using the model, and information can be determined by querying employment system 310 and/or analyzing the results of the A/B testing, which can be used by the research to further tune the model.

In some embodiments, employment system 310 can provide various outputs to researcher 710 in addition to, or alternative to, the information provided to researcher 710 as described above in connection with activities 721-725. As an example, employment system 310 can provide researcher 710 with analytics regarding the model, the results of A/B testing, and/or other suitable information.

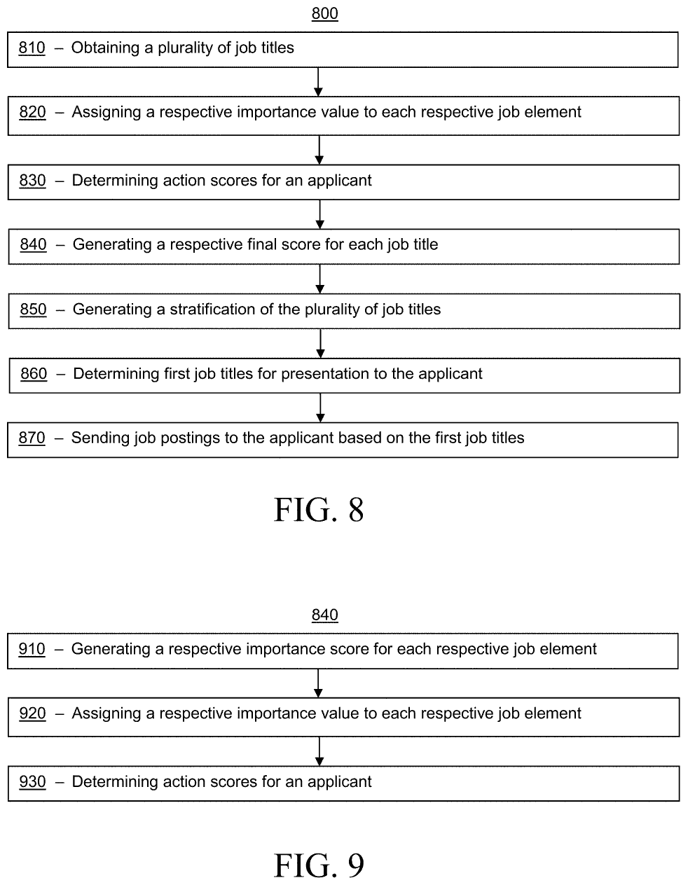

Turning ahead in the drawings, FIG. 8 illustrates a flow chart for a method 800 of evaluating employment opportunities for individuals with disabilities, according to an embodiment. In many embodiments, method 800 can be used to match employment opportunities to applicants based on the disabilities and/or abilities of the applicant and/or the requirements and/or accommodations provided by the job position and/or employer. Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of method 800 can be performed in any suitable order. In still other embodiments, one or more of the procedures, the processes, and/or the activities of method 800 can be combined or skipped.

In many embodiments, system 300 (FIG. 3), employment system 310 (FIG. 3), and/or web server 320 (FIG. 3) can be suitable to perform method 800 and/or one or more of the activities of method 800. In several embodiments, method 800 can be performed by accommodation system 315 (FIG. 3). In these or other embodiments, one or more of the activities of method 800 can be implemented as one or more computing instructions configured to run at one or more processors and configured to be stored at one or more non-transitory computer readable media. Such non-transitory computer readable media can be part of system 300 (FIG. 3), employment system 310 (FIG. 3), and/or web server 320 (FIG. 3). The processor(s) can be similar or identical to the processor(s) described above with respect to computer system 100 (FIG. 1).

In some embodiments, method 800 and other activities in method 800 can include using a distributed network including distributed memory architecture to perform the associated activity. This distributed architecture can reduce the impact on the network and system resources to reduce congestion in bottlenecks while still allowing data to be accessible from a central location.

Referring to FIG. 8, method 800 can include an activity 810 of obtaining a plurality of job titles. Job titles can include a spectrum of various types of jobs, such as accountant, choreographer, nurse, chief executive, geneticist, biochemist, astronomer, forest firefighter, energy engineer, security guard, flight attendant, clinical data manger, for example. In various examples, the number of job titles can be 50, 100, 500, 1000, 1500, or another suitable number.

In many embodiments, each of the plurality of job titles can be associated with a plurality of job elements. These job elements can be categorized into skills, abilities, and work activities. For example, skills can include active learning, active listening, complex problem solving, coordination, critical thinking, etc. Abilities can include arm-hand steadiness, auditory attention, control precision, deductive reasoning, depth perception, memorization, etc. Work activities can include analyzing data or information, assisting and caring for others, coaching and developing others, communicating with persons outside organization, controlling machines, coordinating the work and activities of others, developing and building teams, developing objectives and strategies, repairing and maintaining electronic equipment, etc. In some embodiments, the number of job elements can be 25, 50, 75, 100, 125, 150, or another suitable number.

In several embodiments, method 800 also can include an activity 820 of assigning a respective importance value to each respective job element of the plurality of job elements for each of the plurality of job titles. For example, each of the job elements can be characterized by a coefficient called an importance value, which can be different for different job titles. The importance values can range from low importance (e.g., importance value of 1) to high importance (e.g., importance value of 5). In other embodiments, other ranges can be used. For example, the job element of “memorization” can have an importance value of 1.5 for the job title of “janitor,” but can have an importance value of 3.88 for the job title of “actor,” indicating that memorization has a higher importance weight for actors than janitors. In many embodiments, the job elements can be common across all job titles, but there can be different importance values for the job elements for different job titles, such that a respective importance value is specific to each job title and job element pair. The respective importance value can be independent of the questions and/or action scores described below in connection with activity 830.

In a number of embodiments, method 800 additionally can include an activity 830 of determining action scores for an applicant. The applicant can be similar or identical to applicant 410 (FIG. 4). In several embodiments, each respective action score of the action scores can be based at least in part on a respective ability of the applicant in performing each of a plurality of abilities related to one or more disabilities. In many embodiments, the action scores can be received from the applicant in response to questions, such as part of an self-assessment, as described above in activity 423 (FIG. 4). These assessments can take into account how applicants perceive and evaluate their functional status in daily living through a series of targeted questions. For example, exemplary questions can include the following:
Do you need assistance to walk 100 meters?
Do you have any problem standing up, walking, or moving around?
Do you have any problem performing tasks using your hands?
Do you feel tired?
Do you have any memory problems?
Do you have any vision impairment?
Does your overall condition affect your commuting/traveling?
Does your overall condition affect your social activities?
   Additional or alternative questions can be included. The number of questions in various embodiments can be 10, 15, 20, 25, 30, or another suitable number of questions. Each response receiving from the applicant can be called an action score for that particular question.

The respective action score for each of the plurality of abilities can selected from a range representing full independence (e.g., action score of 0) to full incapacitation (e.g., action score of 10). In other embodiments, different scoring ranges can be used. In many embodiments, the plurality of abilities can cover various different job specifications, such as physical abilities, cognitive abilities, social skills, driving ability, and other suitable abilities.

In several embodiments, method 800 further can include an activity 840 of generating a respective final score for each job title of the plurality of job titles based at least in part on the respective importance values assigned to the plurality of job elements associated with the job title and the action scores for the applicant. Turning ahead in the drawings, FIG. 9 illustrates a flow chart for activity 840 of generating a respective final score for each job title of the plurality of job titles based at least in part on the respective importance values assigned to the plurality of job elements associated with the job title and the action scores for the applicant. Activity 840 is merely exemplary and is not limited to the embodiments presented herein. Activity 840 can be employed in many different embodiments or examples not specifically depicted or described herein. In some embodiments, the procedures, the processes, and/or the activities of activity 840 can be performed in the order presented. In other embodiments, the procedures, the processes, and/or the activities of activity 840 can be performed in any suitable order. In still other embodiments, one or more of the procedures, the processes, and/or the activities of activity 840 can be combined or skipped. In several embodiments, activities 910 and 920 described below can be performed for each respective action score (e.g., associated with each question) of the action scores for the applicant.

In a number of embodiments, activity 840 can include an activity 910 of generating a respective importance score for each respective job element of the plurality of job elements for the job title based on the respective importance value assigned to each respective job element of the plurality of job elements and the respective action score. For example, the importance score for an applicant for a job element of job title can be generated by multiplying the importance value of the job element by the action score (e.g., associated with each question). For example, for the job title of “epidemiologists” and the job element of “active learning, the importance value can be 4.12, and the action score for a first question of “Do you need assistance to walk 100 meters?” can be 10, such that importance score is 41.2. Activity 910 can proceed with generating the respective importance score for each job element for the job title for which the final score is being generated in activity 840. If there are 128 job elements, for example, then there will be 128 importance scores generated for that specific job title for each action score (e.g., question).

In several embodiments, activity 840 also can include an activity 920 of generating a respective total importance score based on the respective importance scores across the plurality of job elements for the job title. For example, the total importance score for a job title for a particular question can be generated by summing up the importance scores across all the job elements for that job title. The job title can have a different total importance score for each action score (e.g., question).

In various embodiments, activity 840 additionally can include an activity 930 of determining the respective final score for the job title based on the respective total importance scores across the action scores (e.g., questions) for the applicant. For example, the final score for a job title can be determined by summing the total importance scores across all the action scores received in response to the questions. Each job title can have a respective final score calculated in this manner for the applicant, so that if there are 967 total job titles, for example, there will be 967 final scores.

Returning to FIG. 8, in a number of embodiments, method 800 additionally can include an activity 850 of generating a stratification of the plurality of job titles based at least in part on the respective final scores for the plurality of job titles. In many embodiments, the stratification can be generated based on a ranking of the job titles using the final scores for the job titles. Those job titles with the lowest final scores are considered more suitable for the applicant, as the closer the final scores are closer to 0, the more functional and/or competent the applicant considers himself/herself to be at the abilities asked above in the questions.

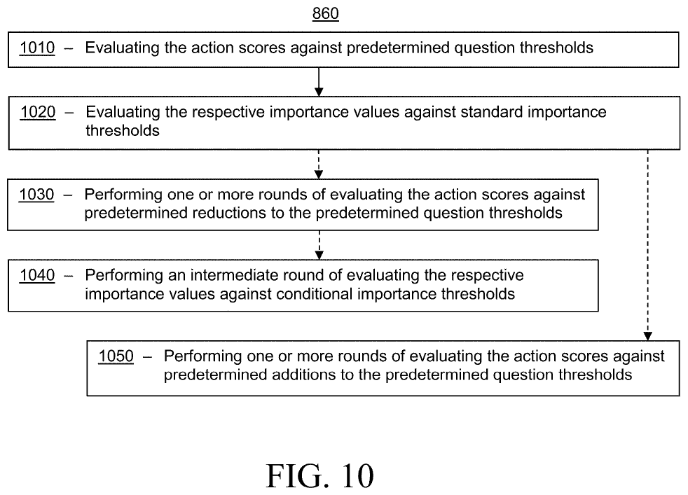

In several embodiments, method 800 further can include an activity 860 of determining first job titles of the plurality of job titles for presentation to the applicant based at least in part on the stratification. Turning ahead in the drawings, FIG. 10 illustrates a flow chart for activity 860 of determining first job titles of the plurality of job titles for presentation to the applicant based at least in part on the stratification. Activity 860 is merely exemplary and is not limited to the embodiments presented herein. Activity 860 can be employed in many different embodiments or examples not specifically depicted or described herein. In some embodiments, the procedures, the processes, and/or the activities of activity 860 can be performed in the order presented. In other embodiments, the procedures, the processes, and/or the activities of activity 860 can be performed in any suitable order. In still other embodiments, one or more of the procedures, the processes, and/or the activities of activity 860 can be combined or skipped.

In some embodiments, each of the plurality of job titles can be categorized in a respective competitiveness bucket. For example, a Bucket A can be used for job titles that are significantly competitive, a Bucket B can be used for job titles that are moderately competitive, and a Bucket C can be used for job titles that are mildly competitive. In other embodiments, other suitable categorizations can be used. In many embodiments, the categorization of competitiveness can be determined for each job title based on the sum of importance values across the job elements. For example, the job titles can be stratified based on these sums of importance values for the job titles. Those job titles in the highest third can be categorized in Bucket A, the next third in Bucket B, and the final third in Bucket C. In other embodiments, thresholds can be used against the sums of importance values to categorize the job titles into one of the buckets. For example, job titles having a sum of importance values greater than 390 can be categorized into Bucket A, job titles having a sum of importance values greater than 350 but below 390 can be categorized into Bucket B, and job titles having a sum of importance values below 350 can be categorized into Bucket C. As an example, some of the job titles can be classified into buckets as shown in Table 1.

TABLE 1

| | Sum of | |
|---|---|---|
| Job Title | Importance Values | Categorization |
| Municipal Fire Fighting and | 445.6 | Bucket A |
| Prevention Supervisors | | |
| Ship and Boat Captains | 413.51 | Bucket A |
| Dentists, General | 411.98 | Bucket A |
| Millwrights | 405.46 | Bucket A |
| Police Patrol Officers | 403.59 | Bucket A |
| Robotic Engineers | 402.98 | Bucket A |
| Computer Systems Engineers/ | 361.83 | Bucket B |
| Architects | | |
| Agricultural Technicians | 361.74 | Bucket B |
| Pathologists | 361.73 | Bucket B |
| Power Plant Operators | 361.55 | Bucket B |
| Surveying Technicians | 361.52 | Bucket B |
| Brickmasons | 361.48 | Bucket B |
| Flight Attendants | 336.19 | Bucket C |
| Dredge Operators | 336.13 | Bucket C |
| Computer Operators | 336.04 | Bucket C |
| Cytotechnologists | 335.92 | Bucket C |
| Food batchmakers | 335.83 | Bucket C |
| Security guards | 334.76 | Bucket C |

In some embodiments, a job element is considered non-important for a job title when it is equal or less than an importance threshold, and can be considered important for the job title when it is higher than the importance threshold. For example, for job titles in Bucket A, the importance threshold can be set to 3.45; for job titles in Bucket B, the importance threshold can be set of 3.6; and for job titles in Bucket C, the importance threshold can be set to 2.9. These importance thresholds that are initially applied in activity 1020 can be considered standard importance thresholds.

In several embodiments, activity 840 can include an activity 1010 of evaluating the action scores for the applicant against predetermined question thresholds associated with the plurality of job elements to determine job elements that the applicant does not capture. If the applicant experiences significant disabilities and/or deficits, this situation can be expressed in higher action scores, indicating that the applicant might not be able to adequately perform various job elements of the job titles. Consequently, the applicant might not be considered a suitable candidate for a job title in which such job elements are considered important, based on the standard importance thresholds.

When a job element is important, in order to evaluate if the applicant can capture (e.g., perform sufficiently) the job element without compromising the safety of the applicant, the question thresholds can be used for each pair of question and job element. For example, for a first question of “Do you need assistance to walk 100 meters?” the question threshold for the job element of explosive strength can be set to 7, but the question threshold for the job element of quality control analysis can be set to 10. For a second question of “Do you have any memory problems?” the question threshold for the job element of explosive strength can be set to 10, but the question threshold for the job element of quality control analysis can be set to 7. In many embodiments, these same question thresholds apply for the same pair of question and job element across all the job titles. These question thresholds can be assigned based on medical expertise.

In many embodiments, when the job element for a job title is important, the action score can be compared to the question threshold. If the action score for the applicant is equal to or lower than the question threshold, the job title can be included in the first job titles. If instead the action score is higher than the threshold, the job title can be excluded from the first job titles.

For example, if the applicant has an action score of 8 for the question “Do you have any problems standing up, walking, or moving around?” and the job element of explosive strength has a question threshold of 7, the applicant is considered to not be able to perform this job element of explosive strength.

In a number of embodiments, activity 860 also can include an activity 1020 of evaluating the respective importance values assigned to the plurality of job elements against standard importance thresholds associated with respective competitiveness buckets to which the plurality of job titles are classified. When the job element is not captured by the applicant, as determined in activity 1010, the importance value of the job element can be evaluated for each job title against the standard importance thresholds to determine if the job element is important to the job title.

Continuing the example, above, in which the applicant cannot perform the job element of explosive strength, the job titles in which explosive strength is considered important will not be included in the first job titles for the applicant. As an example, the job title of Logistics Analysis can be included in the first job titles, as it has an importance value of 1 in Bucket B, which is below the standard importance threshold of 3.6 for Bucket B. By contrast, the job title of Athletes and Sports Competitor can be excluded from the first job titles, as it has an importance value of 3.62 in Bucket A, which is above the standard importance threshold of 3.45 for Bucket A.

In various embodiments, activity 840 optionally can include, after activity 1020, an activity 1030 of performing one or more rounds of evaluating the action scores for the applicant against predetermined reductions to the predetermined question thresholds associated with the plurality of job elements. Activity 1030 can be part of a First Strategy that is applied to further refine the job titles includes in the first job titles.

In many embodiments, a percentage can be determined for each job title. This percentage can be determined by first determining the range of scores that would apply for an applicant with no impairment at all and an applicant that is fully incapacitated in all areas. With no impairment at all, the action scores would all be 0, and the total score across action scores would be 0. With full impairment in all areas, the action scores would all be 10, and the maximum total score would be calculated as the maximum action score (e.g., 10) multiplied by the number of job elements, further multiplied by the maximum value of importance score (e.g., 5), further multiplied by the number of questions. In a simplified example, assume this maximum total score would be 1000, and the minimum total score that would meet the question thresholds for a specific job is 450 points. This means that if an applicant gets 450 points, the applicant will be (1-450/1000)=(1-0.45)=55% match for this job. If the applicant gathers 250 points, the applicant will be (1-250/1000)=(1-0.25)=75% match. If the applicant gathers 50 points, the applicant will be (1-50/1000)=(1-0.05)=95% match for this job. Thus, the applicant should have a match of more or equal to 55% in order to be presented this job title.

In many embodiments, all the jobs in which the applicant managed to surpass the threshold can be included in the first job titles to be presented to the applicant. The ranking of the jobs titles can be formed according to their match percentages from the highest to the lowest. In some embodiments, the jobs that are beyond the threshold can still be presented to the patient, but not highlighted as the ones recommended. The purpose of this First Strategy is to be inclusive, and exclude job titles from the first list rarely, when the applicant has severe deficits. Yet, a Second Strategy, as described below in connection with activity 1050, can be used for such applicants to not be too discriminating.

As introduced above, the First Strategy can include performing one or more rounds of evaluating the action scores for the applicant against predetermined reductions to the predetermined question thresholds associated with the plurality of job elements. Table 2 shows an exemplary set of reductions to be applied to the question thresholds on the various rounds.

TABLE 2

| Round # | Q1 | Q2 | Q3 | Q4 | Q5 | Q6 | Q7 | Q8 | Q9 |
|---|---|---|---|---|---|---|---|---|---|
| 0 | | | | | | | | | |
| 1 | −1 | −1 | −1 | −1 | | | | | |
| 2 | −1 | −1 | −1 | −1 | −1 | | | | |
| 3 | −1 | −1 | −1 | −1 | −1 | | | −1 | |
| 4 | −2 | −2 | −2 | −1 | −1 | | | −1 | |
| 5 | −2 | −2 | −2 | −2 | −1 | | | −1 | |
| 6 | −2 | −2 | −2 | −2 | −2 | −1 | | −2 | |
| 7 | −2 | −2 | −2 | −2 | −2 | −1 | −1 | −2 | |
| 9 | −3 | −3 | −2 | −2 | −2 | −1 | −1 | −2 | −1 |
| 10 | −3 | −3 | −2 | −2 | −2 | −1 | −1 | −2 | −1 |

Round 0 was performed in activity 1010, in which no adjustments were made to the question thresholds. In subsequent rounds, the action scores can be modified based on the reductions listed. These modifications can accumulate in subsequent rounds, becoming increasingly strict, so that more and more job titles are gradually excluded, such that the first job titles can be more suited to the applicant.

For example, Round 1 can apply a reduction of −1 to the thresholds for questions Q1-Q4. Round 2 can retain this reduction, but apply an extra reduction of −1 to question Q5. Round 3 retains these reductions, but applies an extra reduction of −1 to question Q8. If the job element cannot be captured by the applicant, based on these adjusted question thresholds, and the job element is important to the job title, then the job title can be excluded.

In several embodiments, activity 840 further can include an activity 1040 of performing an intermediate round of evaluating the respective importance values assigned to the plurality of job elements against conditional importance thresholds associated with the respective competitiveness buckets to which the plurality of job titles are classified. In order to make job stratification in this First Strategy perform more smoothly, activity 1040 can be used to apply a second condition. The standard importance thresholds can be increased, such as for example, 3.9 for Bucket A, 4.0 for Bucket B, and 3.1 for Bucket C. These increased thresholds can be used as the conditional importance thresholds.

In many embodiments, activity 1040 can be performed when applying the predetermined reductions to the predetermined question thresholds results in a filtering of remaining job titles the job titles exceeding a predetermined threshold in any of the one or more rounds of activity 1030. For example, these conditional importance thresholds can be applied when from one round to the subsequent round, more than 50% of the job titles are eliminated from a bucket. In several embodiments, this condition can be tested after each round.

As a simple example, assume there are 120 job titles with 40 job titles in each bucket after Round 0, and after each round applied in activity 1030, the numbers of job titles remaining in the first job titles are as shown in Table 3.

TABLE 3

| Round # | Bucket A | Bucket B | Bucket C |
|---|---|---|---|
| 0 | 40 | 40 | 40 |
| 1 | 0 | 10 | 40 |
| 2 | 0 | 0 | 10 |
| 3 | 0 | 0 | 0 |

The job titles in Bucket A decrease from 40 in Round 0 to 0 in Round 1, so the condition in activity 1040 is activated. Instead of filtering the action scores against the standard importance thresholds, the conditional importance thresholds are used in an intermediate round between Round 0 and Round 1. For Bucket A, the importance threshold is thus increased from 3.45 to 3.9 for a conditional Round 0A that applies to the job titles in Bucket A. The job titles in Bucket B decrease from 40 in Round 0 to 10 in Round 1, which is a 75% decrease. Similarly, a conditional Round OB can be activated for the job titles in Bucket B, so that the conditional importance threshold of 4.0 applies to the job titles in Bucket B. Bucket C does not lose any jobs from Round 0 to Round 1, so the condition is not activated for Bucket C. After conditional Rounds OA and OB, Round 1 proceeds as usual with the standard importance thresholds. The outcome of Table 3 is thus adjusted as shown in Table 4.

TABLE 4

| Round # | Bucket A | Bucket B | Bucket C |
|---|---|---|---|
| 0 | 40 | 40 | 40 |
| 0A | 10 | | |
| 0B | | 20 | |
| 1 | 0 | 10 | 40 |
| 2 | 0 | 0 | 10 |
| 3 | 0 | 0 | 0 |

The job titles in Bucket A remain at 0 from Round 1 to Round 2, so there is no further activity for Bucket A. The job titles in Bucket B decrease from 10 in Round 1 to 0 in Round 2, which is a 100% decrease. A conditional Round 1B can be activated for the job titles in Bucket B. The job titles in Bucket C decrease from 40 in Round 1 to 10 in Round 2, which is a 75% decrease. A conditional Round 1C can be activated for the job titles in Bucket C, so that the conditional importance threshold of 3.1 applies to the job titles in Bucket C. The outcome of Table 4 is thus adjusted as shown in Table 5.

TABLE 5

| Round # | Bucket A | Bucket B | Bucket C |
|---|---|---|---|
| 0 | 40 | 40 | 40 |
| 0A | 10 | | |
| 0B | | 20 | |
| 1 | 0 | 10 | 40 |
| 1B | | 0 | |
| 1C | | | 25 |
| 2 | 0 | 0 | 10 |
| 3 | 0 | 0 | 0 |

The job titles in Buckets A and B remain at 0 from Round 2 to Round 3, so there is no further activity for those buckets. The job titles in Bucket C decrease from 10 in Round 2 to 0 in Round 3, which is a 100% decrease. A conditional Round 2C can be activated for the job titles in Bucket C. The outcome of Table 5 is thus adjusted as shown in Table 6.

TABLE 6

| Round # | Bucket A | Bucket B | Bucket C |
|---|---|---|---|
| 0 | 40 | 40 | 40 |
| 0A | 10 | | |
| 0B | | 20 | |
| 1 | 0 | 10 | 40 |
| 1B | | 0 | |
| 1C | | | 25 |
| 2 | 0 | 0 | 10 |
| 2C | | | 2 |
| 3 | 0 | 0 | 0 |

In the example described above in connection with activity 1020, the job title of Athletes and Sports Competitor was excluded from the first job titles. With the addition of the conditional round, the job title would be included in the first job titles.

The First Strategy can continue running until there are no job titles included in any bucket, or the final round has been reaches for each bucket. If there are no job titles include in any bucket, the previous round in which there are any job titles can be used as a “Group A.” The job titles in Group A can be stratified from lowest to highest, as the job titles with lower scores are more suitable for the applicant. The job titles of group A can be included at the first of the first job titles to be presented to the applicant. If the number of job titles included in Group A are too few, such as below a threshold (e.g., 50), then the job titles included in the previous round can be used as a “Group B.” Group B will include the job titles of Group A, as well as others. Group A is already at the top of the list, and the remaining job titles in Group B can be stratified from lowest to highest after the job titles in Group A. This procedure can continue, moving up to previous rounds, until there are enough job titles (e.g., more than 50) from each bucket to present to the applicant.

In various embodiments, activity 840 optionally can include, after activity 1020, an activity 1050 of performing one or more rounds of evaluating the action scores for the applicant against predetermined additions to the predetermined question thresholds associated with the plurality of job elements. In the event of an applicant having extremely high action scores, the job titles for the applicant can be eliminated in Round 0, or too few job titles (e.g., less than 50 per bucket) can be presented to the applicant. In this case, a Second Strategy can be activated, which includes activity 1050. Table 7 shows an exemplary set of additions to be applied to the question thresholds on the various rounds.

TABLE 7

| Round # | Q1 | Q2 | Q3 | Q4 | Q5 | Q6 | Q7 | Q8 | Q9 |
|---|---|---|---|---|---|---|---|---|---|
| 0 | | | | | | | 1 | | |
| 1 | | | | | | 1 | 1 | | |
| 2 | | | | | | 1 | 1 | 1 | |
| 3 | | | | | | 1 | 1 | 1 | 1 |
| 4 | 1 | | | | | 1 | 1 | 1 | 1 |
| 5 | 1 | | 1 | | | 1 | 1 | 1 | 1 |
| 6 | 1 | 1 | 1 | | | 1 | 1 | 1 | 1 |
| 7 | 1 | 1 | 1 | 1 | | 1 | 1 | 1 | 1 |
| 9 | 1 | 1 | 1 | 1 | | 1 | 2 | 1 | 1 |
| 10 | 1 | 1 | 1 | 1 | 1 | 2 | 2 | 1 | 1 |

The Second Strategy follows an inverse procedure to the First Strategy described above in connection with activities 1030 and 1040, as the question thresholds are gradually increased. Round 1 introduces an increase of +1 to the question threshold for question Q7. Round 2 retains this increase, but applies an extra rise of +1 in question Q6, and so forth. This Second Strategy can proceed until there are enough job titles available, such as greater than 50, or another suitable threshold. The stratification can be applies as above, based on scores from lowest to highest. In many embodiments, the scores and/or percentages are not presented to the applicant. The job titles added at each step can be placed at the bottom of the list round by round. When the Second Strategy is activated, such as due to action scores that are too high resulting in too few job titles, an advisory note can be included in the display to the applicant that the selection of jobs can still be considered by the applicant, but with caution and with regards to previous experience and a physician's advice, as significant deficits might undermine the performance of the applicant.

Returning to FIG. 8, in a number of embodiments, method 800 additionally can include an activity 870 of sending job postings to the applicant based on the first job titles. For example, if a job title is include in the first job titles, job postings that have a job title categorized within that job title can be included in the job postings sent to the applicant. In many embodiments, these job postings can be displayed to the applicant on a webpage, such as in response to a search for relevant jobs, or sent to the applicant in a message (e.g., email), or a push notification, for example.

In many embodiments, the techniques described herein can beneficially provide a practical application with technological improvements. Specifically, the techniques described herein can provide for automated approach to evaluating employment opportunities for individuals with disabilities. For example, the techniques described herein can advantageously determine jobs to include and/or exclude based on abilities of the applicant that would not otherwise be fully considered. These techniques can send certain relevant job postings to individuals with disabilities for consideration when conventional approaches would not have highlighted these job postings for the applicant. The techniques described herein can solve these technical problems in a manner unique to the context of computer networks. The scoring approach would not be used by humans outside a computer network in view of lack of data and/or unwieldy complexity.

Although employment evaluation for individuals with disabilities has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-9 may be modified, and that the foregoing discussion of certain of these embodiments does not necessarily represent a complete description of all possible embodiments. For example, one or more of the procedures, processes, or activities of FIGS. 4-9 may include different procedures, processes, and/or activities and be performed by many different modules, in many different orders and/or one or more of the procedures, processes, or activities of FIGS. 4-9 may include one or more of the procedures, processes, or activities of another different one of FIGS. 4-9. As another example, the systems within system 300, employment system 310, and/or web server 320 of FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, perform:
obtaining a plurality of job titles, wherein each of the plurality of job titles is associated with a plurality of job elements;
assigning a respective importance value to each respective job element of the plurality of job elements for each of the plurality of job titles;
determining action scores for an applicant, wherein each respective action score of the action scores is based at least in part on a respective ability of the applicant in performing each of a plurality of abilities related to one or more disabilities;
generating a respective final score for each job title of the plurality of job titles based at least in part on the respective importance values assigned to the plurality of job elements associated with the job title and the action scores for the applicant;
generating a stratification of the plurality of job titles based at least in part on the respective final scores for the plurality of job titles;
determining first job titles of the plurality of job titles for presentation to the applicant based at least in part on the stratification; and
sending job postings to the applicant based on the first job titles.

2. The system of claim 1, wherein:
the respective action score for each of the plurality of abilities is selected from a range representing full independence to full incapacitation.

3. The system of claim 1, wherein:
the plurality of abilities comprise physical abilities, cognitive abilities, social skills, and driving ability.

4. The system of claim 1, wherein:
the action scores are received from the applicant in response to questions.

5. The system of claim 1, wherein generating the respective final score for each job title comprises:
for each respective action score of the action scores for the applicant:
generating a respective importance score for each respective job element of the plurality of job elements for the job title based on the respective importance value assigned to each respective job element of the plurality of job elements and the respective action score; and
generating a respective total importance score based on the respective importance scores across the plurality of j ob elements for the job title; and
determining the respective final score for the job title based on the respective total importance scores across the action scores for the applicant.

6. The system of claim 1, wherein determining the first job titles of the plurality of job titles for presentation to the applicant further comprises:
evaluating the action scores for the applicant against predetermined question thresholds associated with the plurality of job elements to determine job elements that the applicant does not capture.

7. The system of claim 6, wherein:
each of the plurality of job titles is categorized in a respective competitiveness bucket; and
determining the first job titles of the plurality of job titles for presentation to the applicant further comprises:
evaluating the respective importance values assigned to the plurality of job elements against standard importance thresholds associated with the respective competitiveness buckets to which the plurality of job titles are classified.

8. The system of claim 7, wherein determining the first job titles of the plurality of job titles for presentation to the applicant further comprises:
performing one or more rounds of evaluating the action scores for the applicant against predetermined reductions to the predetermined question thresholds associated with the plurality of job elements.

9. The system of claim 8, wherein determining the first job titles of the plurality of job titles for presentation to the applicant further comprises:
when applying the predetermined reductions to the predetermined question thresholds results in a filtering of remaining job titles the job titles exceeding a predetermined threshold in any of the one or more rounds:
performing an intermediate round of evaluating the respective importance values assigned to the plurality of j ob elements against conditional importance thresholds associated with the respective competitiveness buckets to which the plurality of j ob titles are classified.

10. The system of claim 7, wherein determining the first job titles of the plurality of j ob titles for presentation to the applicant further comprises:
performing one or more rounds of evaluating the action scores for the applicant against predetermined additions to the predetermined question thresholds associated with the plurality of job elements.

11. A method being implemented via execution of computing instructions at one or more processors, the method comprising:
obtaining a plurality of job titles, wherein each of the plurality of job titles is associated with a plurality of job elements;
assigning a respective importance value to each respective job element of the plurality of job elements for each of the plurality of job titles;
determining action scores for an applicant, wherein each respective action score of the action scores is based at least in part on a respective ability of the applicant in performing each of a plurality of abilities related to one or more disabilities;
generating a respective final score for each job title of the plurality of job titles based at least in part on the respective importance values assigned to the plurality of job elements associated with the job title and the action scores for the applicant;
generating a stratification of the plurality of job titles based at least in part on the respective final scores for the plurality of job titles;
determining first job titles of the plurality of job titles for presentation to the applicant based at least in part on the stratification; and
sending job postings to the applicant based on the first job titles.

12. The method of claim 11, wherein:
the respective action score for each of the plurality of abilities is selected from a range representing full independence to full incapacitation.

13. The method of claim 11, wherein:
the plurality of abilities comprise physical abilities, cognitive abilities, social skills, and driving ability.

14. The method of claim 11, wherein:
the action scores are received from the applicant in response to questions.

15. The method of claim 11, wherein generating the respective final score for each job title comprises:
for each respective action score of the action scores for the applicant:
generating a respective importance score for each respective job element of the plurality of job elements for the job title based on the respective importance value assigned to each respective job element of the plurality of job elements and the respective action score; and
generating a respective total importance score based on the respective importance scores across the plurality of j ob elements for the job title; and
determining the respective final score for the job title based on the respective total importance scores across the action scores for the applicant.

16. The method of claim 11, wherein determining the first job titles of the plurality of j ob titles for presentation to the applicant further comprises:
evaluating the action scores for the applicant against predetermined question thresholds associated with the plurality of job elements to determine job elements that the applicant does not capture.

17. The method of claim 16, wherein:
each of the plurality of job titles is categorized in a respective competitiveness bucket; and
determining the first job titles of the plurality of job titles for presentation to the applicant further comprises:
evaluating the respective importance values assigned to the plurality of job elements against standard importance thresholds associated with the respective competitiveness buckets to which the plurality of job titles are classified.

18. The method of claim 17, wherein determining the first job titles of the plurality of j ob titles for presentation to the applicant further comprises:
performing one or more rounds of evaluating the action scores for the applicant against predetermined reductions to the predetermined question thresholds associated with the plurality of job elements.

19. The method of claim 18, wherein determining the first job titles of the plurality of j ob titles for presentation to the applicant further comprises:
when applying the predetermined reductions to the predetermined question thresholds results in a filtering of remaining job titles the job titles exceeding a predetermined threshold in any of the one or more rounds:
performing an intermediate round of evaluating the respective importance values assigned to the plurality of j ob elements against conditional importance thresholds associated with the respective competitiveness buckets to which the plurality of j ob titles are classified.

20. The method of claim 17, wherein determining the first job titles of the plurality of j ob titles for presentation to the applicant further comprises:
performing one or more rounds of evaluating the action scores for the applicant against predetermined additions to the predetermined question thresholds associated with the plurality of job elements.
